(19) United States
(12) Patent Application Publication
(10) Pub. No.: US 2006/0277121 A1
(43) Pub. Date: Dec. 7, 2006

(54) System and method for E-market planning and management

(75) Inventor: Chia-Chun Lee, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/144,489

(22) Filed: Jun. 2, 2005

(51) Int. Cl. G06Q 10/00

(52) U.S. Cl. 705/28

(57) ABSTRACT

A system and a method for E-market planning and management applied to an Internet environment are proposed to solve incompatibility between electronic transaction systems and to link different industries, thereby solving problems encountered in the existing B2B (Business-to-Business) electronic transaction technology. The E-market planning and management system includes a B2B e-hub module, an Integrated Device Manufacturer (IDM) control module, and a distributor processing module. The B2B e-hub and the IDM control module are not only capable of proceeding electronic transactions between one another, but also between the IDM control module and the distributor processing module. The E-market planning and management system is advantageous to implement as a B2B2B system configuration to overcome the drawbacks of the existing technology for B2B electronic transaction.

### FIELD OF THE INVENTION

The present invention relates to methods and systems for electronic transactions and more particularly, to a system and method for planning and arrangement of electronic business transactions.

### BACKGROUND OF THE INVENTION

The Internet has rapidly become one of the main resources for buyers and sellers to exchange their merchandises and/or services. The rise of the Internet as a successful outlet for selling and purchasing of merchandises and/or services has boosted the electronic market and become an inevitable trend of business dealing internationally. To keep up with this ever-growing trend, most enterprises, if not all, follow with great enthusiasm and interest in the development of E-market since many of their merchandise sales are conducted on the Internet and many other businesses conduct at least a portion of their sales via the Internet. In particular, enterprises focus most on across-the-board electronization to accelerate the speed of procurements in order to reduce direct or indirect costs of materials. As such, Electronic Data Interchange (EDI) technology has been used at a primary stage as a standard mode for data exchange between different enterprises. However, the EDI technology provides only point-to-point transmission, which is inefficient to implement nowadays. Besides, its high construction cost hinders rapid development.

In the prior art, the types of business transaction systems commonly adopted between product manufacturers and distributors are for example Business-to-Business (B2B) electronic data exchange platforms, electronic transaction platform mode, and distribution management system platforms, all of which are designed to facilitate the exchange of information and data of transactions and the distribution management of stock replenishments and inventory and merchandise selling. This poses a big cost problem for most product manufacturers since they are required to set up appropriate and individual Business-to-Business B2B electronic exchange platforms, electronic transaction platform modes, and distribution management system platforms in order to comply with individual system configurations and platforms adopted by different distributors. Moreover, since different systems are constructed for different distributors to suit individual needs, it causes incompatibility between the systems and further leads to huge barriers in intercommunicating between different distributors. Consequently, data transparency is not realized, leading to inefficient products and merchandises planning and management.

Besides, as far as the commonly used commercial systems are concerned, for example, an Enterprise Resources Planning (ERP) system or a Supply Chain Management (SCM) system for industrial use, there are often many restrictions on the users' access rights to limit accessibility of end users in consideration of safety of the system database, which often do not apply to the Internet network environment but to the simple intranet environment used within an enterprise, thereby undesirably limiting the applicability.

In the process of conducting electronic business transactions, the incompatibility between different systems of the enterprises have brought about bottlenecks that urgently demand a solution to meet the needs of the industry. A need, therefore, exists for a system and method for E-market planning and management applied to the Internet network environment to meet the compatibility requirements of the industry. More specifically, a need exists for a system and a method for E-market planning and management over the Internet that can be implemented via a B2B e-hub, thereby allowing product manufacturers to be able to save resources of manpower, money and long-term maintenance that are normally required for setting up the systems themselves, and by which distributors would not be required to accommodate to different manufacturers by adopting and connecting with different Information Technology (IT) systems. Furthermore, a need exists for a system and method for E-market planning and management over the Internet to enable the provision of the business transaction electronic information platform websites to effectively and rapidly upgrade the ability of E-transformation of medium- to small-scale enterprises, thereby increasing enterprise capabilities in managing product distribution and maintenance control so as to decrease the overall cost as a result.

### SUMMARY OF THE INVENTION

It is therefore an objective of the present invention to provide a novel system and method for E-market planning and management applicable to the Internet environment, which can solve the problem of system incompatibility between different electronic transaction systems by the provision of a B2B2B electronic transaction system architecture and further enable the integration of cross-industries to solve the problems as encountered in the current B2B electronic transaction system.

It is another objective of the present invention to provide a novel system and method for E-market planning and management applicable to the Internet environment using a B2B2B electronic transaction system architecture, which can prevent the drawbacks of suppliers having to self-construct their own systems and also distributors having to connect with different IT systems in order to comply with different suppliers, thereby saving resources of human power, money and long-term system maintenance that are required for constructing the system such that a rapid upgrade of the electronization in industry can be accomplished.

It is another objective of the present invention to provide a novel system and method for E-market planning and management applicable to the Internet environment using a B2B2B electronic transaction system architecture through the mode of B2B e-hub, which is capable of integrating the internal systems of different enterprises or the industrial workstation processing systems, such that the resources and services of electronic business transactions can be used effectively to full advantage.

The system for planning and managing E-market according to the present invention comprises a B2B e-hub used by at least one supplier for managing production and ordering information and an Integrated Device Manufacturer (IDM) control module for handling the order information to/from the B2B e-hub and providing the distributors with controlling mechanisms of incoming/selling/storage of merchandises.

The method for E-market planning and management comprising the following steps. Firstly, the B2B e-hub compares a safety stock level with an existing stock level and calculates a suggested quantity to be purchased so as to transmit the calculated information to the IDM control module. Then, the IDM control module receives the suggested purchasing quantity sent from the B2B e-hub for inputting order requirements according to the suggested quantity and transmits the order requirement information to the B2B e-hub. The B2B e-hub receives the order requirement information sent from the IDM control module and performs operations to verify the order, check the stock, confirm the order based on the order requirement information, and then transmits an order confirmation message to the IDM control module. The IDM control module executes and confirms the order, and after the distributors issued the payments, transmitting cash flow information to the B2B e-hub. The B2B e-hub receives cash flow information from the IDM control module and checks the status of incoming payments.

The B2B e-hub of the present invention differs from the conventional mode of the B2B information exchange platform in that the business transaction electronic information website of the present invention implements an e-Hub mode of operation that has the advantages of open accessibility and common applicability using websites to link all sorts of dealing information and act as a public platform that can be shared by all manufacturers and distributors openly. Compared to the conventional B2B information exchange platform in the prior art, the present invention is capable of avoiding the necessity of constructing individual systems such that a great deal of expenses involved can be saved. The present invention is also able to cross the hedges and barriers between different manufacturers/distributors and systems such that the sharing and accessing of data is possible between different enterprises, thereby improving data planning transparency and ultimately increasing production management efficiency.

### BRIEF DESCRIPTION OF DRAWINGS

The present invention can be more fully understood by reading the following detailed description of the preferred embodiments, with reference made to the accompanying drawings, wherein:

FIG. 1 is a schematic block diagram showing the configuration of a system for E-market planning and management of the present invention;

FIG. 2 is a schematic diagram showing the operating status of the system for E-market planning and management of the present invention in serving a customer;

FIG. 3 is an operational flowchart showing the procedural steps involved in the system for E-market planning and management as illustrated in FIG. 1 in proceeding a first embodiment of a method for E-market planning and management of the present invention; and

FIG. 4 is an operational flowchart showing the procedural steps involved in the system for E-market planning and management as illustrated in FIG. 1 in proceeding a second embodiment of the method for E-market planning and management of the present invention.

### DETAILED DESCRIPTION OF PREFERRED EMBODIMENTS

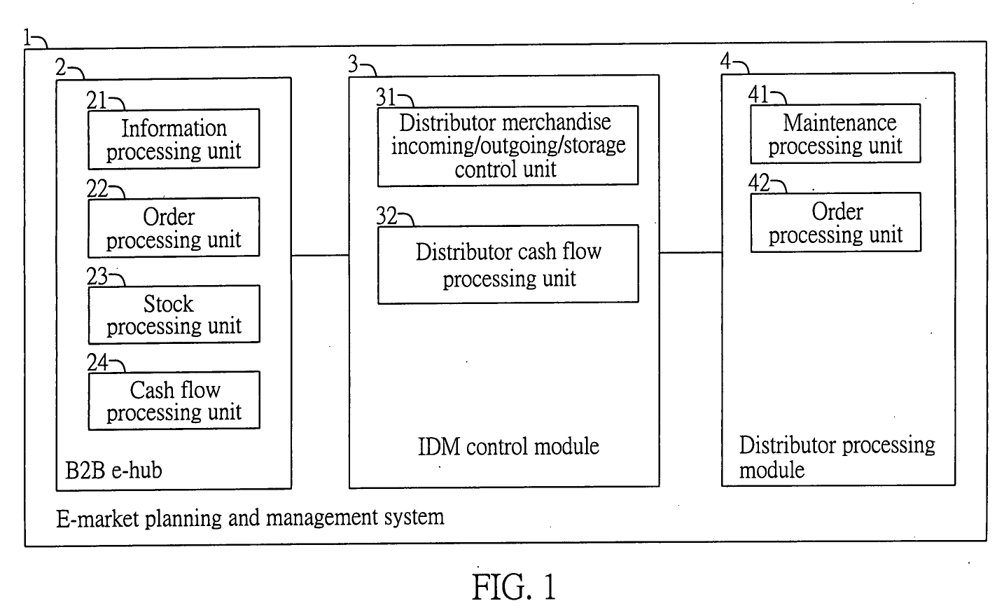

FIG. 1 illustrates the configuration of the system for E-market planning and management of the present invention. As shown, the E-market planning and management system 1 of the present invention includes a B2B e-hub 2, an Integrated Device Manufacturer (IDM) control module 3, and a distributor module 4.

The B2B e-hub 2 includes an information processing unit 21, an order processing unit 22, a stock processing unit 23, and a cash flow processing unit 24. The information processing unit 21 is used to receive and process product information, sales promotion information, marketing information, contact data of the distributors, and/or computer educational information from product suppliers; and, the information processing module 21 also receives client information and order data sent by the distributors. The order processing unit 22 receives order information sent form the IDM control module 3, and subsequently processes the received orders by verifying the orders, checking the stock and confirming orders. After an order is confirmed, the order processing module 21 transmits a order confirmation message to the IDM control module 3. The stock processing unit 23 can assist distributors in placing orders and managing stock, while the stock processing unit is used to compare the safety inventory with the existing stock level to further calculate a recommended quantity to be purchased, and subsequently transmit the calculated information to the IDM control module 3. The cash flow processing unit 24 confirms electronic payment operations and receives cash flow information sent from the IDM control module 3, and further checks the status of incoming payments so as to instruct the warehouse distribution department to schedule for delivery based on the issued delivery lists after the checking of payment is verified.

The B2B e-hub can provide parameter setting function of suggested purchasing lists, whereby it automatically generates suggested purchasing lists to the IDM control module as a purchasing basis for distributors. The module further enables the IDM control module and the distributor module to cross-examine and verify order operations, and directly exchange information of orders with core suppliers. The B2B e-hub 2 is provided as a data exchange center between the IDM control module 3 and the distributor module 4. Also, the B2B e-hub 2 provides web service functionality to link the B2B system with external systems and various analytical reports to enable the distributor module 4 to get hold of all the sales information as well as the current status of distributors' stock, which also allows the suppliers to schedule and make production plans accordingly.

The IDM control module 3 includes a distributor merchandise incoming/outgoing/storage control-unit 31 and a distributor cash flow processing unit 32. The distributor merchandise incoming/outgoing/storage control unit 31 uploads the settings of safety stock level/transaction stock and stock information to the B2B e-hub 2 each day, allowing the stock processing unit 23 of the B2B e-hub 2 to assist distributors in placing orders and managing stock, wherein the stock processing unit 23 compares the safety stock level with the existing stock level to calculate a suggested quantity to be purchased and transmits this calculated information to the IDM control module 3 for subsequent processing. After the distributor merchandise incoming/outgoing/storage control unit 31 receives information of suggested purchasing quantity sent by the stock processing unit 23 of the B2B e-hub 2, IDM control module 3 subsequently inputs and processes order information according to the suggested purchasing quantity, and then transmits order information to the order processing unit 22 of the B2B e-hub 2.

When the order processing unit 22 of the B2B e-hub 2 receives an order sent from the IDM control module 3, it proceeds to verify the order, check the stock, confirm the order and then transmits information of the confirmed order to the distributor merchandise incoming/outgoing/storage control unit 31 of the IDM control module 3 for subsequent processing of payment. After the payment is received by the distributor, the distributor cash flow processing unit 32 transmits the payment information to the cash flow processing unit 24 of the B2B e-hub 2, wherein the cash flow processing unit 24 receives cash flow information from the IDM control module 3 and checks the status of the incoming payments, so as to instruct the warehouse distribution department to schedule for delivery based on the issued delivery lists after the checking of payment is verified The distributor merchandise incoming/outgoing/storage control unit 31 performs operations of inspecting, inputting the incoming merchandises and recording the quantity thereof.

The IDM control module 3 automatically receives the collected customer order information sent from the distributor processing module 4 for subsequent processing; further, the IDM control module 3 automatically receives suggested purchase lists from the core suppliers sent by the B2B e-hub 2 so as to make procurements accordingly, and confirms with distributors to rapidly complete procedure of procurement; in addition, the IDM control module 3 provides linking of electronic banking transfer service for quick entry into a bank electronic transfer system to carry out payment transfer, thereby shortening the time required for delivery and procurement. The IDM control module 3 automatically receives information of merchandises sent from core suppliers to efficiently get hold of marketing strategies of the suppliers for the merchandises to strengthen mutual collaboration of market expansion. Moreover, the IDM control module can also assist distributors in their daily business operations, such as, sales management, storehouse management, procurement management and financial management, etc.; it further provides a variety of statistical and analytical reports to enable distributors to fully control the growth of their businesses and the sales trends.

The distributor processing module 4 is used by the distributors, and includes a maintenance processing unit 41 and an order receiving unit 42, wherein the maintenance processing unit 41 is used to perform login procedures of the membership and maintenance, whereas the order processing unit 42 is used to receive and transfer orders to a warehouse distribution department for subsequent processing of merchandises delivery via an E-Market (EM).

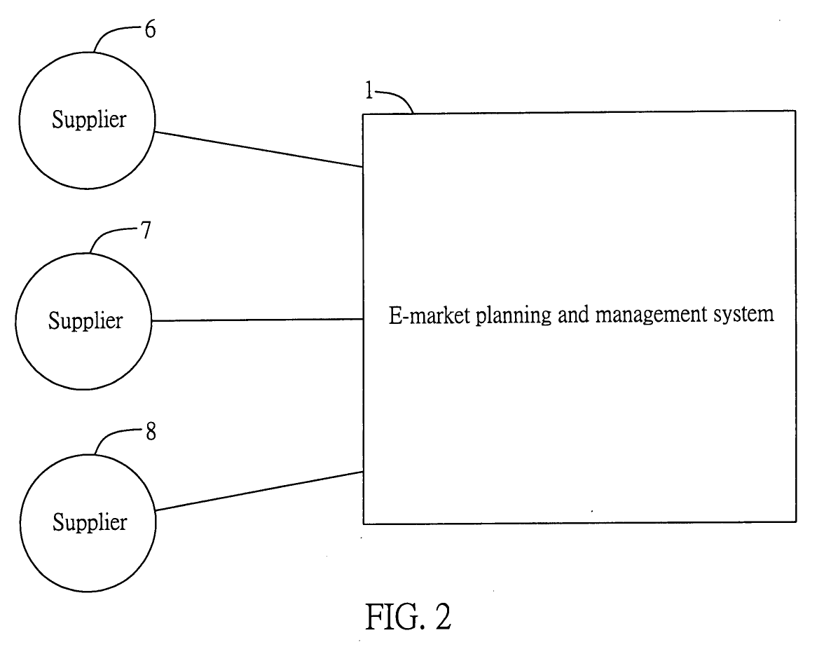

FIG. 2 is a schematic diagram showing the operating status of the system for E-market planning and management of the present invention in serving a supplier. As shown, the E-market planning and management system 1 of the present invention can be used to serve one supplier 6 or more than one customer such as suppliers 6, 7, and 8.

The E-market planning and management system 1 and the B2B e-hub 2 of the present invention differ from the conventional mode of the B2B information exchange platform in that the B2B e-hub 2 of the present invention implements an e-Hub mode of operation for combining data together that provides the advantages of open accessibility and common applicability. A public platform is used to link all sorts of dealing information that can be shared by all suppliers 6, 7, and 8 openly. Compared to the conventional B2B information exchange platform in the prior art, the present invention is capable of avoiding the necessity of constructing individual system for suppliers 6, 7 and 8, such that a great deal of expenses involved can be saved. The present invention is also able to bridge the barriers between different enterprises and systems such that the sharing and accessing of data is possible between different enterprises, thereby improving data planning transparency and ultimately increasing product management efficiency.

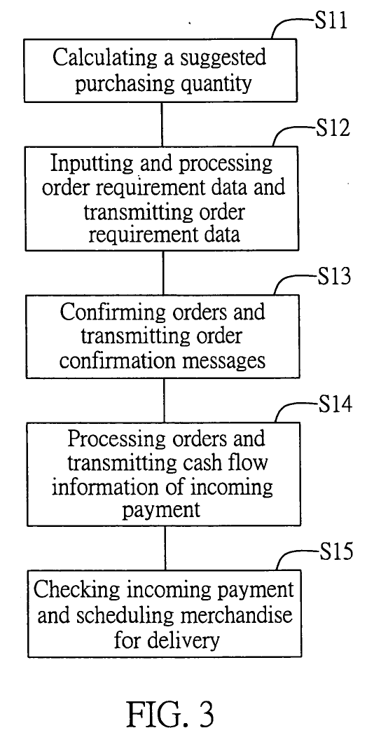

FIG. 3 is an operational flowchart showing the procedural steps involved in the system for E-market planning and management as illustrated in FIG. 1 in carrying out a first embodiment of a method for E-market planning and management of the present invention. As shown in a first step S11, the stock processing unit 23 compares safety stock level with the existing stock level and calculates a suggested quantity to be purchased, and then transmits the calculated information to the IDM control module 3. Thereafter, a step S12 is followed.

In step S12, the distributor merchandise incoming/outgoing/storage control unit 31 receives information of suggested purchasing quantity sent by the stock processing unit 23 of the B2B e-hub 2, and subsequently inputs and processes order information requirements according to the suggested purchasing quantity, and then transmits the order requirement information to the order processing unit 22 of the B2B e-hub 2, wherein the order processing unit 22 also receives order information sent from the retail processing 4. Thereafter, a step S13 is followed.

In step S13, the order processing unit 22 receives the order data sent from the IDM control module 3 and proceeds to verify the order, check the stock, confirm the order and then transmit a order confirmation message back to the distributor merchandise incoming/outgoing/storage control unit 31 of the IDM control module 3 for subsequent processing of payment. Thereafter, a step S14 is followed.

In step S14, the distributor merchandise incoming/outgoing/storage control unit 31 confirms the order. After the distributors have issued the payments, the distributor cash flow processing unit 32 transmits the payment information to the cash flow processing unit 24 of the B2B e-hub 2. Thereafter, a step S15 is followed.

In step S15, the cash flow processing unit 24 receives cash flow information sent from the IDM control module 3 and checks the status of the incoming payments, thereby instructing the warehouse distribution department to schedule merchandises for delivery based on delivery lists.

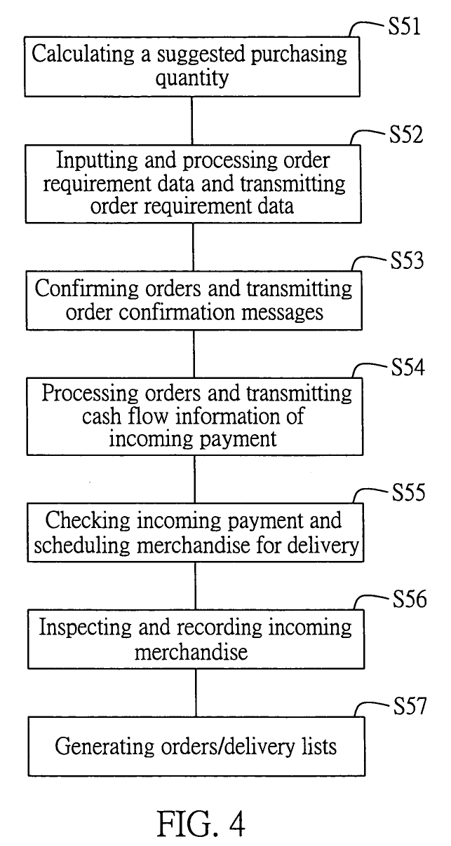

FIG. 4 is a flow diagram showing the procedural steps involved in the system for E-market planning and management as illustrated in FIG. 1 in carrying out a second embodiment of the method for E-market planning and management of the present invention. As shown in the drawing, in a first step S51, the stock processing unit 23 compares safety stock level with the existing stock level to suggest a quantity to be ordered, and then transmits the calculated information to the IDM control module 3. Thereafter, a step S52 is followed.

In step S52, the distributor merchandise incoming/outgoing/storage control unit 31 receives information of suggested purchasing quantity sent by the stock processing unit 23 of the B2B e-hub 2, and subsequently inputs and processes order information requirements according to the suggested purchasing quantity, and then transmits the order requirement information to the order processing unit 22 of the B2B e-hub 2, wherein the order processing unit 22 also receives order information sent from the retail processing 4. Thereafter, a step S53 is followed.

In step S53, the order processing unit 22 receives the order data sent from the IDM control module 3 and proceeds to verify the order, check the stock, confirm the order and then transmit a order confirmation message back to the distributor merchandise incoming/outgoing/storage control unit 31 of the IDM control module 3 for subsequent processing of payment. Thereafter, a step S54 is followed.

In step S54, the distributor merchandise incoming/outgoing/storage control unit 31 confirms the order. After the distributors have issued the payments, the distributor cash flow processing unit 32 transmits the payment information to the cash flow processing unit 24 of the B2B e-hub 2. Thereafter, a step S55 is followed.

In step S55, the cash flow processing unit 24 receives cash flow information sent from the IDM control module 3 and checks the status of the incoming payments, thereby instructing the warehouse distribution department to schedule merchandises for delivery based on delivery lists. Thereafter, a step S56 is followed.

In step S56, the distributor merchandise incoming/outgoing/storage control unit 31 performs procedures of inspecting and inputting of the incoming merchandises and recording the quantity of the merchandises. Thereafter, a step S57 is followed.

In step S57, the distributor merchandise incoming/outgoing/storage control unit 31 generates ordering and/or delivery lists to the distributor processing module 4 for delivering the ordered merchandises to the distributors.

Compared to the conventional B2B information exchange platform in the prior art, the present invention is capable of avoiding the necessity of constructing individual systems such that a great deal of expenses involved can be saved. The present invention is also able to bridge the barriers between different suppliers/distributors and systems such that the sharing and accessing of data is possible, thereby improving data planning transparency and ultimately increasing product management efficiency.

The present invention has been described using exemplary preferred embodiments. However, it is to be understood that the scope of the present invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for E-market planning and management, applied to an Internet environment for solving a problem of incompatibility between electronic transaction systems, the Internet environment comprising an Integrated Device Manufacturer (IDM) control module and a B2B (Business-to-Business) e-hub, and allowing different product suppliers and distributors to be linked together, the method for E-market planning and management comprising the steps of:
having the B2B e-hub compare a safety stock level with an existing stock level and calculate a suggested purchasing quantity so as to transmit information of the suggested purchasing quantity to the IDM control module;
having the IDM control module receive the suggested purchasing quantity from the B2B e-hub to input order requirement information according to the suggested purchasing quantity and transmit the order requirement information to the B2B e-hub;
having the B2B e-hub receive the order requirement information from the IDM control module to verify an order in the order requirement information and/or check stocks and confirm the order, and after the order is confirmed, transmitting an order confirmation message to the IDM control module for subsequent processing;
having the IDM control module execute and confirm the order, and after the distributors issue payment, transmitting cash flow information to the B2B e-hub; and
having the B2B e-hub receive the cash flow information from the IDM control module and check whether the payment is received.

2. The method of claim 1, further comprising a step of instructing a warehouse distribution department to schedule merchandise for delivery after confirming the payment is received.

3. The method of claim 2, further comprising the steps of:
having the IDM control module perform operations of inspecting incoming merchandise and/or inputting a quantity thereof and record the inspection data and/or the inputted merchandise quantity data; and
having the IDM control module generate an order and/or a delivery list and deliver ordered merchandise to the distributors.

4. A system for E-market planning and management, applied to an Internet environment for solving a problem of incompatibility between electronic transaction systems, and allowing different product suppliers and distributors to be linked together, the system for E-market planning and management comprising:
a B2B e-hub for allowing at least one of the suppliers to manage product and order information; and
an IDM control module for processing the order information to/from the B2B e-hub and providing the distributors with controlling mechanisms of incoming/selling/storage of merchandise.

5. The system of claim 4, further comprising a distributor processing module for providing the order information to the B2B e-hub.

6. The system of claim 4, wherein the B2B e-hub comprises:
an information processing unit for receiving and processing at least one of product information, sales promotion information, marketing information, contact data of the distributors and computer education information, and for receiving client and order information from the distributors;
an order processing unit for receiving the order information from the IDM control module, and for verifying an order in the order information and/or checking stocks, so as to transmit an order confirmation message to the IDM control module after the order is confirmed;
a stock processing unit for assisting the distributors in placing orders and managing stock, and for comparing a safety stock level with an existing stock level to calculate a suggested purchasing quantity and transmit information of the suggested purchasing quantity to the IDM control module; and
a cash flow processing unit for checking whether electronic payment for ordered merchandise is received from the distributors and for receiving cash flow information related thereto from the IDM control module so as to instruct a warehouse distribution department to schedule merchandise for delivery after confirming the payment is received.

7. The system of claim 6, wherein the IDM control module comprises:
a distributor merchandise incoming/outgoing/storage control unit for providing settings of merchandise safety stock level and transactions, uploading stock information to the B2B e-hub, receiving the suggested purchasing quantity from the stock processing module of the B2B e-hub, and inputting and processing order requirement information based on the suggested purchasing quantity to transmit the order requirement information to the order processing unit of the B2B e-hub; and
a distributor cash flow processing unit for transmitting the cash flow information to the cash flow processing unit of the B2B e-hub.

8. The system of claim 4, further comprising a distributor processing module applied to the distributors, wherein the distributor processing module comprises:
a maintenance processing unit for performing membership logins and maintenance; and
an order receiving unit for receiving, processing and passing orders to a warehouse distribution department for scheduling merchandise for delivery accordingly via an E-market.

9. The system of claim 5, further comprising a distributor processing module applied to the distributors, wherein the distributor processing module comprises:
a maintenance processing unit for performing membership logins and maintenance; and
an order receiving unit for receiving, processing and passing orders to a warehouse distribution department for scheduling merchandise for delivery accordingly via an E-market.

10. The system of claim 6, further comprising a distributor processing module applied to the distributors, wherein the distributor processing module comprises:
a maintenance processing unit for performing membership logins and maintenance; and
an order receiving unit for receiving, processing and passing orders to the warehouse distribution department for scheduling merchandise for delivery accordingly via an E-market.

11. The system of claim 7, further comprising a distributor processing module applied to the distributors, wherein the distributor processing module comprises:
a maintenance processing unit for performing membership logins and maintenance; and
an order receiving unit for receiving, processing and passing orders to the warehouse distribution department for scheduling merchandise for delivery accordingly via an E-market.
